(19) United States
(12) Patent Application Publication
(10) Pub. No.: US 2004/0190416 A1
(43) Pub. Date: Sep. 30, 2004

(54) Integrating configuration of combined electronic equipment

(76) Inventor: Atsushi Kakiuchi, Takefu-city (JP)

Correspondence Address: FLYNN THIEL BOUTELL & TANIS, P.C., 2026 RAMBLING ROAD, KALAMAZOO, MI, 49008-1699, US

(21) Appl. No.: 10/796,862

(22) Filed: Mar. 9, 2004

(30) Foreign Application Priority Data
Mar. 18, 2003 (JP) 2003-072962

(51) Int. Cl. G11B 7/00

(52) U.S. Cl. 369/53.11

(57) ABSTRACT

It is an object of the invention to provide an integrating configuration of combined electronic equipment having circuit boards and a power supply circuit board which are arranged therein so as to render the combined electronic equipment comprising optical disc recording and reproducing unit and a video cassette recording and reproducing unit, which are disposed in parallel with each other, more compact. A DVD recording and reproducing unit and a video cassette recording and reproducing unit are arranged in parallel with each other on a bottom face frame, wherein the DVD recording and reproducing unit is supported by supporting members so that a height of a DVD insertion portion of the DVD recording and reproducing unit becomes substantially the same as that of a video cassette insertion portion of the video cassette recording and reproducing unit. A DVD control circuit board and the power supply circuit board are disposed between a free space defined between the DVD recording and reproducing unit and the bottom face frame.

### FIELD OF THE INVENTION

The invention relates to an integrating configuration of combined electronic equipment provided with a recording and reproducing unit of an optical disc (hereinafter referred to as optical disc recording and reproducing unit) such as DVDs (Digital Versatile Discs) and a recording and reproducing unit of a video cassette (hereinafter referred to as video cassette recording and reproducing unit).

### BACKGROUND OF THE INVENTION

A large capacity recording and reproducing unit such as DVDs and so forth has been recently come into practical use, and equipment combined with a video cassette recording and reproducing unit, which has been used so far, has been developed. More specifically, if the respective recording and reproducing units are provided separately, a power supply and so forth are redundantly provided in each unit, and hence if the units are combined with each other to allow the overlapped components to be used in common, thereby bringing an advantage of merit for rendering the combined equipment compact in size. However, it is inevitable that the width of the combined unit becomes larger if the recording and reproducing units are disposed horizontally to combine with each other, while the height thereof becomes higher if they are disposed vertically compared with a case of the single unit, and hence it is required that an interior layout of the combined equipment is devised to minimize the entire size.

As an internal layout of such combined electronic equipment, for example, Patent Reference 1 of JP-A 2002-50171 discloses that a first reproducing unit and a second reproducing unit are disposed horizontally on the upper face of a chassis constituting a bottom face of a housing, and a substrate constituting a main control circuit and so forth made up of a CPU and so forth is provided on a back face of an upper face panel 10. Meanwhile, Patent Reference 2 of JP-A 9-73766 discloses that a circuit board is disposed on the upper and lower sides of a frame of a mechanical part in an optical disc unit.

In the case where optical disc recording and reproducing unit and a video cassette recording and reproducing unit are integrally combined with each other, the latter has to be large in outer dimensions such as a width, a height and a depth compared with the former because the size of the optical disc is different from that of the video cassette. Accordingly, in the case of considering the combination of these unit, the outer dimensions of the video cassette recording and reproducing unit become one restriction condition.

Further, the circuit boards of respective recording and reproducing unit become large in packaging or mounting area of the electronic components as units are rendered in high performance. As shown in the patent reference 1, in the case where the circuit board is provided on the back face of the upper panel, if the mounting area is formed to have the same size as the circuit board as it is, the width and the depth of the equipment is defined by the circuit board, so that the combined unit can not compact in size. Although it is considered that the electronic components are mounted on both sides of the circuit board so as to be rendered compact in size, resulting in the increase of a manufacturing cost of the circuit board. Further, although it is considered that the circuit boards are disposed on upper and lower portions of a housing, as disclosed in Patent Reference 2, the height of the unit has to be high by that amount.

Further, although both the recording and reproducing units are integrally combined with each other to be commonly used, a power supply circuit board is generally laid out on the back face of the housing because a power supply cord is generally attached to the back face of the housing, resulting in the necessity of taking a depth space of the housing by that amount.

### SUMMARY OF THE INVENTION

Accordingly, it is an object of the invention to provide an integrating configuration of combined electronic equipment having circuit boards and a power supply circuit board which are arranged therein so as to render the combined electronic equipment comprising optical disc recording and reproducing unit and a video cassette recording and reproducing unit, which are disposed in parallel with each other, more compact.

The integrating configuration of combined electronic equipment according to the invention having a housing provided with therein an optical disc recording and reproducing unit having an optical disc insertion portion at a front face thereof, a first circuit board having a control circuit of the optical disc recording and reproducing unit, a video cassette recording and reproducing unit having a video cassette insertion portion at a front face thereof and arranged in parallel with the optical disc recording and reproducing unit, a second circuit board having a control circuit of the video cassette recording and reproducing unit, and a power supply circuit board, characterized in that the optical disc recording and reproducing unit is supported by a plurality of supporting members so that the insertion portion of the optical disc recording and reproducing unit becomes substantially the same height as the insertion portion of the video cassette recording and reproducing unit, the first circuit board is disposed between the optical disc recording and reproducing unit and a bottom face of an interior of the housing, the second circuit board is disposed between the video cassette recording and reproducing unit and the bottom face of the interior of the housing, and the power supply circuit board is integrated with the second circuit board so as to be disposed between the first circuit board and the second circuit board, and disposed between the optical disc recording and reproducing unit and the bottom face of the interior of the housing. Further, the integrating configuration is characterized in that the first circuit board has wiring patterns at both faces thereof, and the second circuit board has a wiring pattern at one face thereof. Still further, the integrating configuration is characterized in that external connection terminals, which are exposed from the back face of the housing, are attached to rear end portions of the first circuit board and the second circuit board. Furthermore, the integrating configuration is characterized in that a transformer mounted on the power supply circuit board is disposed such that a core thereof is placed horizontally relative to a face of the power supply circuit board. Still furthermore, the integrating configuration is characterized in that at least one of the supporting members is disposed between the first circuit board and the power supply circuit board.

With the configuration of the integrating configuration of combined. electronic equipment of the invention, the power supply circuit board can be disposed between the optical disc recording and reproducing unit and the bottom face of the interior of the housing, the depth dimension of the entire equipment can be reduced by that amount, and can be rendered compact in size. More specifically, a free space can be secured between the optical disc recording and reproducing unit and the bottom face of the interior of the housing by supporting the optical disc recording and reproducing unit by a plurality of supporting members so as to render the insertion portion of the optical disc recording and reproducing unit being substantially the same in height as that of the video cassette. Accordingly, the power supply circuit board, on which electronic components such as a transformer are mounted, can be disposed in the free space, thereby rendering a depth space of the power supply circuit board which has been disposed on the back face of the housing unnecessary, thereby rendering the depth dimension compact in size by that amount. Since the height of the entire equipment is determined by the height of the video cassette recording and reproducing unit, in the same manner as the conventional one, the entire equipment does not become large.

Further, since the power supply circuit board is disposed between the first circuit board and the second circuit board, the power supply circuit board can be integrated with the second circuit board, thereby rendering wiring cords between the first and second circuit boards unnecessary to hold down a manufacturing cost and to stop the generation of a noise caused by the wiring cords. Still further, it is possible that the power supply circuit board can be freely changed in the manner that it can be integrated with or separated from the first circuit board, thereby increasing the flexibility of design.

The positional relation between the height of the optical disc recording and reproducing unit and that of the video cassette are rendered substantially the same means a positional relation where an operator can set these units at substantially the same height when setting the optical disc and the video cassette.

For the first circuit board, wiring patterns are formed on both faces thereof to enable electronic components to be mounted on both faces, thereby rendering the circuit board compact in size, and securing a free space between the optical disc recording and reproducing unit and the bottom face of the interior of the housing, more efficient layout disposition can be attained. For the second circuit board, the wiring pattern is formed on only one face thereof to render a mounting space of the electronic components thin as much as possible, thereby restraining the height of the entire equipment from becoming large. More specifically, since the free space between the optical disc recording and reproducing unit and the bottom face of the interior of the housing has a room in the direction of the height, when the electronic equipment are mounted on both faces, thereby reducing the width dimension to secure the installing space of the power supply circuit board. Still further since an interval between the video cassette recording and reproducing unit in which the second circuit board is disposed and the bottom face of the interior of the housing needs a height which is as small as possible, thereby restraining the height of the entire equipment from becoming large.

Further, since the external connection terminals, which are exposed from the back face of the housing, are attached to the rear end portions of the first circuit board and the second circuit board, the external terminals can be attached to the first and second circuit boards without using a wiring code, thereby restraining a noise from entering therein.

Further, since the transformer mounted on the power supply circuit board is disposed such that a core thereof is placed horizontally relative to the face of the circuit board, the height dimension of the power supply circuit board is restrained, the power supply circuit board can be laid out in a free space between the optical disc recording and reproducing unit and the bottom face of the interior of the housing.

Still further, since at least one of the supporting members is disposed between the first circuit board and the power supply circuit board, it is not necessary to form holes which are provided by penetrating the support members in the circuit boards, thereby simplifying the design of the circuit boards and holding down the manufacturing cost thereof.

### BRIEF DESCRIPTION OF THE DRAWINGS

FIG. 1 is a perspective view of an entire external appearance of combined electronic equipment provided with an embodiment of the invention;

FIG. 2 is a perspective view showing a state where an upper face frame is removed in FIG. 1;

FIG. 3 is a disassembling perspective view of the embodiment of the invention;

FIG. 4 is a front view of the embodiment of the invention; and

FIG. 5 is a plan view of the embodiment of the invention.

### PREFERRED EMBODIMENT OF THE INVENTION

The embodiment of the invention is now described in detail.

The embodiment set forth hereunder is preferable concrete example to carry out the invention, they are technically restricted variously but the invention is not limited to the embodiment unless specifically describing that the invention is limited.

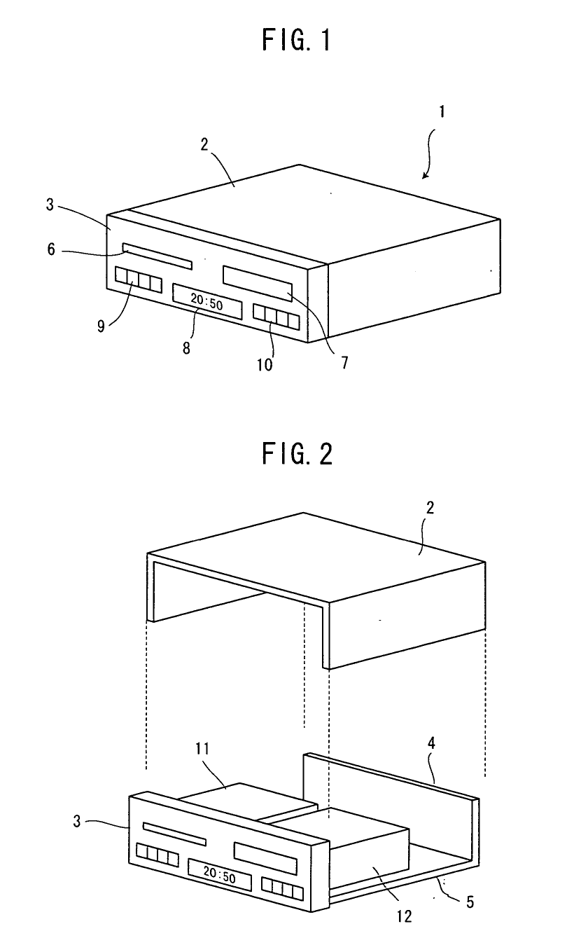

FIG. 1 is a perspective view of an entire external appearance of combined electronic equipment provided with an embodiment of the invention, and FIG. 2 is a perspective view showing a state where an upper face frame 2 is removed. A housing of the combined electronic equipment 1 comprises the upper face frame 2, a front face panel 3, a back face frame 4 and a bottom face frame 5 wherein the upper frame 2, the front face panel 3, and the back face frame 4 are screwed onto the bottom face frame 5 and fixed thereto.

The upper frame 2 is formed in the letter C so as to constitute upper and side faces of the housing. A DVD insertion port 6 and a video cassette insertion port 7 are formed on the front face panel 3 and a display unit 8 is attached to the front face panel 3. Operating buttons 9 and 10 for operating a DVD and a VCR are disposed under the DVD insertion port 6 and the video cassette insertion port 7, and attached thereto. A DVD recording and reproducing unit 11, a video cassette recording and reproducing unit 12, a circuit board and so forth are disposed on the bottom face frame 5 and fixed thereto by screws and so forth.

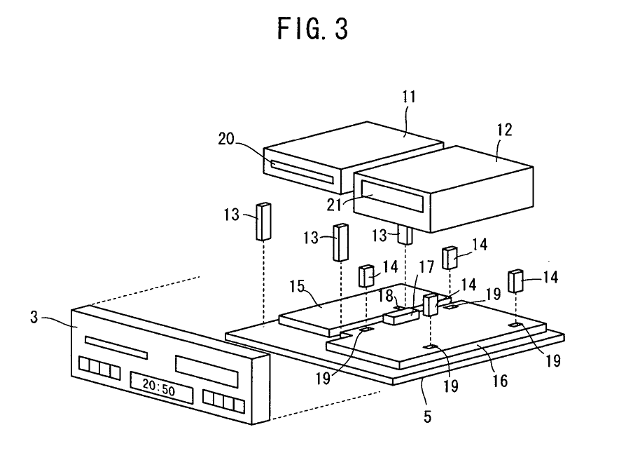

FIG. 3 is a schematic perspective view illustrating components by disassembling the attachment state of components onto the upper face of the bottom face frame 5. The DVD recording and reproducing unit 11 and the video cassette recording and reproducing unit 12 are disposed horizontally on the upper face of the bottom face frame 5 in parallel with each other.

The DVD recording and reproducing unit 11 are supported by three supporting members 13 at the position spaced away from the upper face of the bottom face frame 5 by a given height, which height is set such that a DVD insertion portion 20 is substantially the same in height as a video cassette insertion portion 21. The supporting members 13 are fixed to the bottom face frame 5 at their lower ends by screws and engaged with the periphery of the lower face of the DVD recording and reproducing unit 11 at their upper ends to support the DVD recording and reproducing unit 11.

The video cassette recording and reproducing unit 12 are supported by four supporting members 14 at the position spaced away from the upper face of the bottom face frame 5 by a given height, and the supporting members 14 are fixed to the bottom face frame 5 at their lower ends by screws and engaged with the periphery of the lower face of the video cassette recording and reproducing unit 12 at their upper ends to support the video cassette recording and reproducing unit 12 of a DVD.

A DVD control circuit board 15 is disposed between the DVD recording and reproducing unit 11 and the bottom face frame 5, while a VCR control circuit board 16 is disposed between the video cassette recording and reproducing unit 12 and the bottom face frame 5. A power supply circuit board 17 is disposed between the DVD control circuit board 15 and the VCR control circuit board 16, and the VCR control circuit board 16 and the power supply circuit board 17 are integrated with each other. The power supply circuit board 17 is disposed between the DVD recording and reproducing unit 11 and the bottom face frame 5.

The DVD control circuit board 15 is disposed such that the front end thereof is positioned at the back face side of two supporting members 13 which are fixed to the front face of the DVD control circuit board 15, and a notched portion 18 is formed at the portion where the remaining supporting member 13 which is fixed to the back face side is attached. In such a manner, since the remaining supporting member 13 is disposed between the DVD control circuit board 15 and the power supply circuit board 17, it is not necessary to bore the DVD control circuit board 15 to form the hole through which the supporting member 13 penetrates, thereby simplifying the designing and manufacturing processes of the DVD control circuit board 15. Further, the VCR control circuit board 16 is bored to form attachment holes through which the supporting members 14 penetrate, and a notched portion is formed at the attachment portion of the supporting member 13 fixed to the front face thereof.

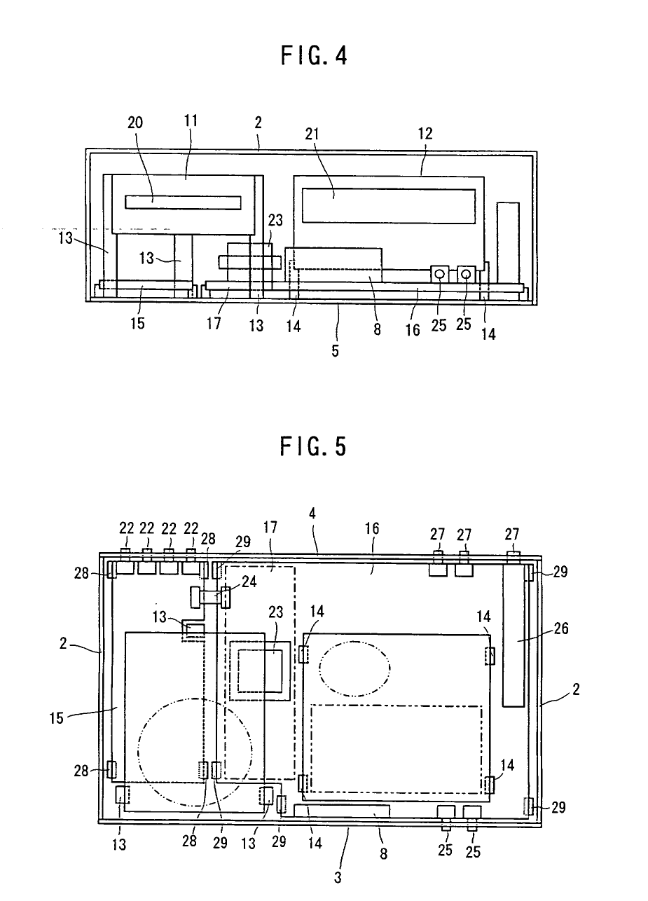

FIG. 4 is a front view showing a state where the components are attached to the upper face of the bottom face frame 5 as viewed from the front thereof, and FIG. 5 is a plan view as viewed from the upper face. As shown in FIG. 4, since the size of the DVD recording and reproducing unit 11 is different from that of the video cassette recording and reproducing unit 12, the former becomes lower in height than the latter, and hence if the DVD insertion portion 20 is positioned at substantially the same height as the video cassette insertion portion 21, a free space is generated between the DVD recording and reproducing unit 11 and the bottom face frame 5. The DVD control circuit board 15 and the power supply circuit board 17 are disposed in this free space.

Since there is a room in the free space to some extent, wiring patterns are formed on both faces of DVD control circuit board 15 to mount the electronic components on both faces thereof, thereby rendering the DVD control circuit board 15 compact in size and allowing the DVD control circuit board 15 to have a slender shape in the longitudinal direction to obtain a sufficient space in which the power supply circuit board 17 is disposed. Further, if external connection terminals 22 for the DVD are directly attached to the rear end of the DVD control circuit board 15, the former can be attached to the latter without the intermediary of a wiring cord and so forth, thereby restraining an influence of a noise.

Although components such a transformer and so forth are mounted on the power supply circuit board 17, since there generates a room in the free space to some extent, a bulky transformer can be disposed in the free space. Particularly, if thee is employed a transformer of a lateral type in which a core of the transformer is substantially horizontally arranged relative to the bottom face frame 5, the height of the transformer can be restrained to some extent, thereby disposing the power supply circuit board 17 with sufficient room. Although the DVD control circuit board 15 and the power supply circuit board 17 are connected to each other by a wiring cord 24, since the VCR control circuit board 16 and the power supply circuit board 17 are integrated with each other, a wiring cord other than the wiring cord 24 is not needed, the combined electronic equipment is configured that a noise caused by the wiring cord becomes very small.

Since the VCR control circuit board 16 forms wiring patterns at its lower face and mounts electronic components on one face thereof, a mounting space is made thin. In this case, the electronic components each having leads are mounted on the upper face and soldered on the lower face, thereby rendering the vertical mounting space thin. Further, electronic components having low height such as chips and so forth are mounted on the part where the video cassette recording and reproducing unit 12 is mounted, thereby allowing the mounting space not to be thick. Since the video cassette recording and reproducing unit 12 is the highest among the components disposed inside the housing of the combined electronic equipment 1, the thickness of the VCR control circuit board 16 is made thin as much as possible, thereby rendering the height of the combined electronic equipment 1 low. The display unit 8 and external connection terminals 25 are directly attached to the front end of the VCR control circuit board 16, and a tuner 26 and external connection terminals 27 are directly attached to the rear end thereof.

Supporting legs 28 are attached to the DVD control circuit board 15 at four corners thereof and the DVD control circuit board 15 are supported while spaced away from the bottom face frame 5 by a given interval. Likewise, the circuit board formed by integrating the VCR control circuit board 16 and the power supply circuit board 17 is also supported by supporting legs 29 while spaced away by a given interval. Since the circuit boards are supported by the supporting legs while spaced away from the bottom face frame 5 by a given interval, heat and so forth generated in the circuit boards can be efficiently emitted outside, and also impact applied to the circuit boards can be suppressed.

With the electronic components are laid out as set forth above, a length of the combined electronic equipment can be reduced by 20% compared with a case where the power supply circuit board is separately disposed on the back face of the combined electronic equipment. Further, the width direction and height direction of the combined electronic equipment can be maintained as they are, thereby rendering the combined electronic equipment compact in size compared with the conventional combined electronic equipment.

What is claimed is:

1. An integrating configuration of combined electronic equipment having a housing provided with therein an optical disc recording and reproducing unit having an optical disc insertion portion at a front face thereof, a first circuit board having a control circuit of said optical disc recording and reproducing unit, a video cassette recording and reproducing unit having a video cassette insertion portion at a front face thereof and arranged in parallel with said optical disc recording and reproducing unit, a second circuit board having a control circuit of said video cassette recording and reproducing unit, and a power supply circuit board;
wherein said optical disc recording and reproducing unit is supported by a plurality of supporting members so that the insertion portion of said optical disc recording and reproducing unit becomes substantially the same in height as the insertion portion of the video cassette recording and reproducing unit;
said first circuit board is disposed between said optical disc recording and reproducing unit and a bottom face of an interior of said housing;
said second circuit board being disposed between said video cassette recording and reproducing unit and the bottom face of the interior of said housing; and
said power supply circuit board is integrated with said second circuit board so as to be disposed between said first circuit board and said second circuit board, and disposed between said optical disc recording and reproducing unit and the bottom face of the interior of said housing.

2. The integrating configuration of combined electronic equipment according to claim 1, wherein said first circuit board has wiring patterns at both faces thereof, and said second circuit board has a wiring pattern at one face thereof.

3. The integrating configuration of combined electronic equipment according to claim 1, wherein external connection terminals, which are exposed from the back face of said housing, are attached to rear end portions of said first circuit board and said second circuit board.

4. The integrating configuration of combined electronic equipment according to claim 1, wherein a transformer mounted on said power supply circuit board is disposed such that a core thereof is placed horizontally relative to a face of said power supply circuit board.

5. The integrating configuration of combined electronic equipment according to claim 1, wherein at least one of the supporting members is disposed between said first circuit board and said power supply circuit board.
